(19) United States
(12) Patent Application Publication
(10) Pub. No.: US 2018/0129642 A1
(43) Pub. Date: May 10, 2018

(54) SYSTEMS AND METHODS FOR AUTOMATIC APPLICATION OF FORMULAS TO TABULAR DATA CELLS

(71) Applicants: Erik Rucker, Seattle, WA (US); Thomas P. Maliska, JR., Olympia, WA (US)

(72) Inventors: Erik Rucker, Seattle, WA (US); Thomas P. Maliska, JR., Olympia, WA (US)

(21) Appl. No.: 15/344,349

(22) Filed: Nov. 4, 2016

(51) Int. Cl. G06F 17/24; G06F 3/0484

(52) U.S. Cl. CPC G06F 17/246; G06F 3/04847; G06F 17/247

(57) ABSTRACT

In some embodiments, technical problems relating to maintaining programmed behavior in tabular data cells are overcome by automatically generating and inserting formulas in interrelated cells. This may be done by reference to declarations of formulas (as by example in a formula table overlay on the sheet design or template, or in a formula editor using defined cell and column locations or defined variables), along with rules defining the order of precedence for assertion in reference to available cell data. In some embodiments, evaluation sequences or priorities may be automatically determined, and/or may be configurable by establishing precedence rules in a master row or hidden row. Some embodiments can determine, in some systems of formulas, where user entries in cells do not match the expected values for the cell, and explain why another result is correct or what is the expected type of entry or value for the cell.

### SUMMARY

This summary is provided to introduce a selection of concepts in a simplified form that are further described below in the Detailed Description. This summary is not intended to identify key features of the claimed subject matter, nor is it intended to be used as an aid in determining the scope of the claimed subject matter.

In some embodiments, a computing device configured to provide a self-programming tabular data interface is provided. The computing device is configured to receive an entry of a formula into a first tabular data cell, wherein the formula performs a calculation that refers to at least a second tabular data cell; automatically determine an inverse of the formula; and automatically insert the inverse of the formula into the second tabular data cell.

In some embodiments, a computing device for inferring tabular data processing rules without human intervention is provided. The computing device is configured to receive an entry of a formula into a first tabular data cell, wherein the formula performs a calculation that refers to at least a second tabular data cell and a third tabular data cell; automatically rearrange the formula to solve for the second tabular data cell to create a first rearranged formula; associate the first rearranged formula with the second tabular data cell; automatically rearrange the formula to solve for the third tabular data cell to create a second rearranged formula; and associate the second rearranged formula with the third tabular data cell.

In some embodiments, a computing device for providing a tabular data management interface is provided. The computing device is configured to store a formula execution hierarchy that indicates one or more prerequisites for automatically evaluating one or more formulas in the tabular data management interface; receive an input into a first column of the tabular data management interface; determine, using the formula execution hierarchy, a formula in a second column of the tabular data management interface that can be executed using the input into the first column; and automatically execute the formula in the second column using the input into the first column.

### DESCRIPTION OF THE DRAWINGS

The foregoing aspects and many of the attendant advantages of this invention will become more readily appreciated as the same become better understood by reference to the following detailed description, when taken in conjunction with the accompanying drawings, wherein:

FIGS. 1A-1C are illustrations of tabular data as managed by exemplary embodiments of systems according to various aspects of the present disclosure;

FIGS. 2A-2C are illustrations of tabular data as managed by exemplary embodiments of systems according to various aspects of the present disclosure;

FIGS. 3A and 3B are illustrations of tabular data as managed by exemplary embodiments of systems according to various aspects of the present disclosure;

FIGS. 4A and 4B are further illustrations of tabular data as managed by exemplary embodiments of systems according to various aspects of the present disclosure;

FIGS. 5A and 5B are further illustrations of tabular data as managed by exemplary embodiments of systems according to various aspects of the present disclosure; and

FIG. 6 is a block diagram that illustrates aspects of an exemplary computing device appropriate for use with embodiments of the present disclosure.

### DETAILED DESCRIPTION

Computing systems that provide the capability of managing data, formatting, and programming in an electronic spreadsheet format or tabular format are common. Indeed, the management of data in tabular format is a common capability of computing devices, and tabular data management utilities have proliferated. Most tabular data management systems allow for the entry of data into cells arranged into rows and columns. Some tabular data management systems also allow the computation of values for cells using formulas.

Embodiments of the present disclosure address technical problems concerning the use and behavior of column cell values based on interrelated cells. Prior art would require specific programming of spreadsheet behavior in order to make the column cell formulas program themselves independently, or would determine an execution order based on which column/cell receives data values first. However, it is difficult to maintain such programming overlays and to make them comply with expected behavior in the spreadsheet, especially when changes are made to the formulas in the sheet, and more so when changes are made by non-programmers doing data entry, spreadsheet maintenance, adapting spreadsheets for other uses, and the like. Other prior art would flag calculations as incomplete or give error codes/notices for missing cell variable data or incorrect references within formulas. However, given the complexity of the references when there are many cross-referenced formulas, or for a sheet of reasonable size, it is difficult for end users to remember and trace through sheets for the source of errors.

In some embodiments of the present disclosure, the technical problems of having to maintain such programmed behavior are overcome by automatically generating and inserting formulas in interrelated cells. Automatically generating and inserting formulas maintains spreadsheet consistency, correctness of evaluation, and avoids human error. This is done by reference to declarations of formulas (as by example in a formula table overlay on the sheet design or template, or in a formula editor using defined cell and column locations or defined variables), along with rules defining the order of precedence for assertion in reference to available cell data. In some embodiments, evaluation sequences or priorities may be automatically determined, and/or may be configurable by establishing precedence rules in a master row or hidden row. Some embodiments of the present disclosure can determine, in some systems of formulas, where user entries in cells do not match the expected values for the cell, and explain why another result is correct or what is the expected type of entry or value for the cell. This permits the system to flag cells requiring corrections due to data insertion error, to automatically correct data where appropriate, and in general will convert a cell data value into the result of a formula rather than force a static data entry.

In some embodiments, a formula may be associated with a first cell. The formula may be keyed into the cell by the user, pasted into the cell by the user, associated with the cell by the user using a management tool, associated with the cell by virtue of being associated with a template row or with a column of the cell, and/or via any other technique. The formula may refer to one or more other cells. In cases where the formula does refer to one or more other cells, some embodiments of the system of the present disclosure may automatically rearrange or solve the formula for each of the other cells and insert each rearranged formula in the corresponding cell. Hence, each of the cells that relate to the formula will have a separate version of the formula that can calculate the content of the cell if the other cells referenced in the formula contain values.

Because some embodiments of the present disclosure will generate interrelated formulas in multiple cells, a new technical problem arises in that it is difficult to determine which cells entries are correct when values are hand-entered, and which cells should have the calculated value take precedence. In some embodiments of the present disclosure, when a user provides input to insert content to a first cell, the system is configured to inspect the other columns. If the system can find formula definitions that reference the first cell in other cells, then the system adds the input content to the first cell and evaluates the formulas in the other cells to see if formulas and/or values can be consistently evaluated using the content inserted by the user. However, if the other cells already include values that are not consistent with the input value, the system may not be able to tell which value should be retained.

Accordingly, in some embodiments of the present disclosure, a system is provided that allows a user to specify a set of precedence rules for interrelated cells. In some embodiments, the precedence rules may operate on a column-by-column basis. A precedence rule may define which column or cell contains valid data and which column should be recalculated or cleared upon entry of new data (or editing of existing data). In some embodiments, precedence rules may be established for a set of columns within a separate user interface (such as a preferences dialog, a header portion or footer portion of an interface separate from a main section of the interface, and/or the like).

Precedence rules may use any suitable characteristic of a column or cell to determine whether an entry in the column or cell causes other columns or cells to recalculate, or whether the current entry is not excepted. One example of a precedence rule is “order of entry.” With an order-of-entry rule, an earlier entered value is presumed to be correct if later-entered data is contradictory. Upon attempting to enter a new value that would contradict an automatically generated value or would otherwise cause an earlier-entered value in another cell to be invalid, an error may be displayed, the old value may be replaced, or any other suitable action that preserves the earlier-entered value may be taken. In some embodiments, the system may preserve a cell-level change history log, which helps enable the system to determine which values were manually entered and which were entered earlier than others.

Another example of a precedence rule is “type of entry.” For type-of-entry rule, the method used to insert the value into a given cell determines whether it should receive precedence or not. For example, a value entered via a paste or import operation may receive precedence over a contradictory value that was entered by hand. As another example, a value entered by hand may receive precedence over a contradictory value in another cell that was entered by automatic execution of a formula. In some embodiments, the cell-level change history log may record the method by which values were entered in order to enable such functionality.

Yet another example of a precedence rule is “column order” or “cell precedence.” In such a rule, columns and/or cells are ranked in relation to each other, such that values in columns or cells of higher rankings receive precedence over values in columns or cells of lower rankings. Such rules may explicitly list each column or cell, or may provide a general order (such as prioritizing columns further to the left over columns further to the right; prioritizing cells higher in the sheet over cells lower in the sheet, and/or the like). Such rules may be applied to the sheet as a whole, or may be assigned to individual cells or columns and move with the cells or columns if they are rearranged.

While some examples of precedence rules are listed above, these examples should not be seen as limiting. In some embodiments, other precedence rules may be used that are not explicitly listed above.

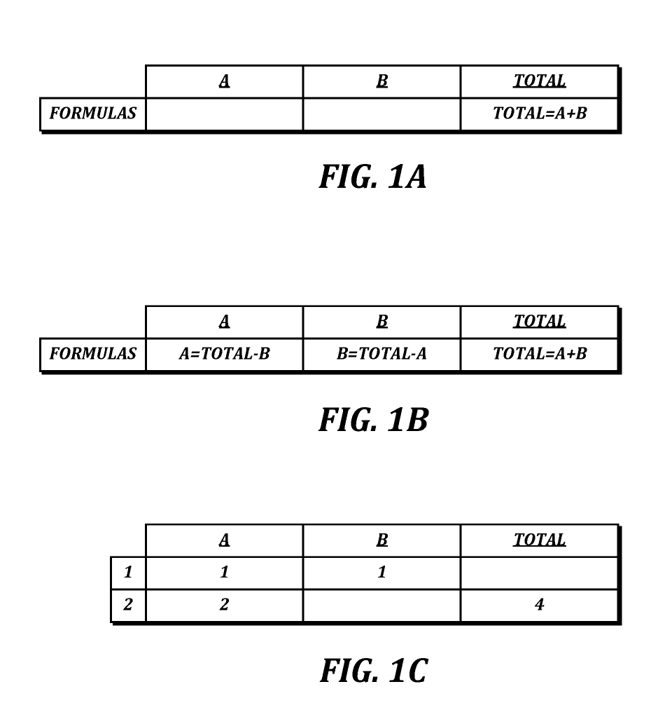

FIGS. 1A-1C are illustrations of tabular data as managed by exemplary embodiments of systems according to various aspects of the present disclosure. Three columns are illustrated: “A,” “B,” and “Total.” A single row is illustrated in FIGS. 1A and 1B, and is labeled “Formulas.” In some embodiments, the “Formulas” row may be separate from a set of data rows in the tabular data. In some embodiments, formulas may be entered directly into the same cells which may otherwise hold values, but are hidden during display in favor of the calculated or entered values. FIGS. 1A and 1B show formulas in a separate row for ease of illustration.

As shown in FIG. 1A, a single formula has been associated with the “Total” column. The formula calculates a value for the cell in the “Total” column based on the values in the “A” column and the “B” column. No entries have been made in the “A” column or the “B” column. FIG. 1B illustrates formulas in the “A” column and the “B” column that have been automatically generated by the system based on the formula entered in the “Total” column. The automatically generated formulas were created by solving the formula in the “Total” column for the referenced values. In some embodiments, the automatically generated formulas may be created upon detection of the entry of the formula in the “Total” column. In some embodiments, the automatically generated formulas may be created upon receiving a command from a user to do so, or in response to any other suitable trigger.

FIG. 1C illustrates behavior of rows in the tabular data having the formulas of FIG. 1B. As illustrated, row 1 has values that were entered for column “A” and column “B.” In some embodiments, selection of cell [Total:1] may cause the formula in the cell to be evaluated. The resulting value (“2”) may be entered as data into the cell, may be used as an autocomplete suggestion, may be used to provide a consistency check against a value entered into the cell, and/or for any other reason, including without limitation in other expressions referencing the cell or column. As illustrated, row 2 has values that were entered for column “A” and column “Total.” Accordingly, selection of cell [B:2] may cause the formula in the cell to be evaluated. Again, the resulting value (“2”) may be entered as data into the cell, may be used as an autocomplete suggestion, may be used to provide a consistency check against a value entered into the cell, or for any other reason. In some embodiments, the formula execution may be triggered by an event other than the selection of a blank cell. For example, the formula may be triggered by the input of the data values in the other cells, such that the formula may be executed once all of its referenced cells contain entered or calculated values. Executing a formula once all of its referenced cells contain values allows complex sets of functions to be calculated without requiring complicated manual entry of individual rules relating various columns to each other.

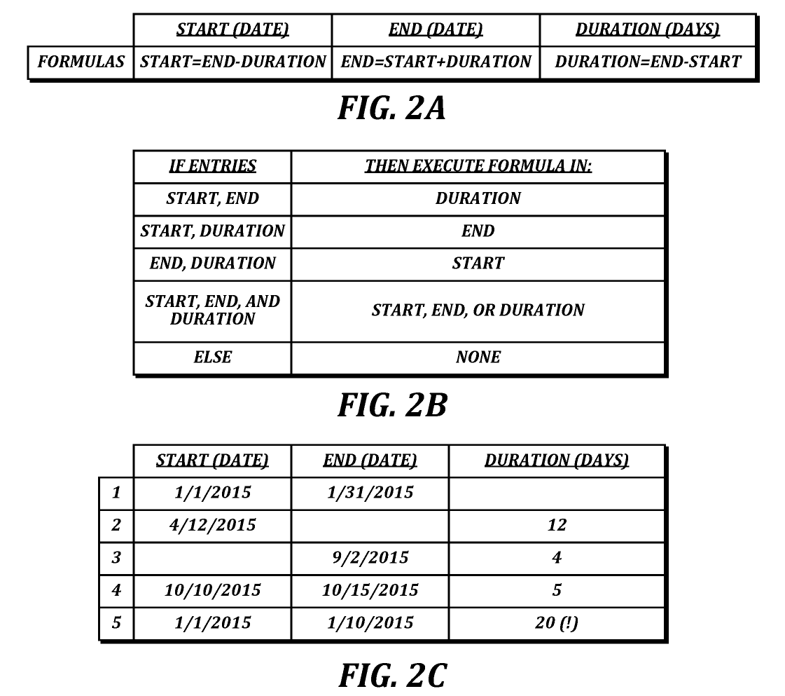

FIGS. 2A-2C are illustrations of tabular data as managed by exemplary embodiments of systems according to various aspects of the present disclosure. Similar to FIGS. 1A and 1B, FIG. 2A illustrates a formula row for tabular data that includes three columns: “start,” “end,” and “duration.” The values in the “start” and “end” columns are of a “date” type, and the value in the “duration” column is of a “days” or other number type. In some embodiments, the specified types may be used by the system to limit the values that may be entered into a cell to only value instances of the type. For example, the “date” type may allow an entry of strings like “11/12/2016,” “Nov. 12, 2016,” and/or other strings that can be parsed into a valid date, but would not allow entry of strings that would not create a valid date, like “99/99/2” or “dog.” In some embodiments, the specified types may be used by the system to format an otherwise untyped value entered into the cell.

FIG. 2A also illustrates formulas associated with each of the columns: The formula in the “duration” column calculates a difference in days between the value in the “start” column and the value in the “end” column. The “start” column and “end” column have complementary formulas, which may have been automatically generated by the system upon entry of the formula in the “duration” column, or may have been manually entered. In some embodiments, the automatic generation of the formulas in the “start” and “end” columns may take the data types into account to determine whether the rearranged formula would produce a value of an acceptable type, or may include casting the result of the formula into an acceptable type. In some embodiments, simple operators such as addition or subtraction may make appropriate casts between data types such as dates and integers. In some embodiments, appropriate complementary functions may be substituted instead. For example, if the formula in the “duration” column includes a function such as NETDAYS( ) which accepts two dates as input and returns an integer number of days between the dates, the system may know that the complementary formula for NETDAYS( ) is a simple addition or subtraction operation that automatically performs the proper type casting.

FIG. 2B illustrates an exemplary embodiment of a set of precedence rules based on value entries for automatically executing the formulas illustrated in FIG. 2A. The illustrated precedence rules may be evaluated in order from top to bottom in order to determine which formulas should be executed based on the column entries. As illustrated, if values exist in the “start” and “end” columns, the formula in the “duration” column will be executed. If values exist in the “start” and “duration” columns, then the formula in the “end” column will be executed. If values exist in the “end” and “duration” columns, then the formula in the “start” column will be executed. If values exist in all of the “start,” “end,” and “duration” columns, then any or all of the formulas may be executed. Finally, if none of these conditions is met (e.g., only one of the values is present or none of the values are present), then none of the formulas are executed. In some embodiments, the precedence rules may be automatically determined based on the referenced cells of each formula, and a formula may be executed if all of its referenced cells have entered values. In some embodiments, the precedence rules may be automatically determined, and may then be manually reordered or edited to provide a different order of precedence.

FIG. 2C illustrates behavior of rows of tabular data having the formulas of FIG. 2A and the precedence rules of FIG. 2B. In row 1, values have been entered for “start” and “end,” and so the formula in “duration” will be executed to calculate the value “30” for cell [Duration:1], which may be inserted into the cell, used as an autocomplete suggestion, used to check a manually entered value, or for any other purpose. In row 2, values have been entered for “start” and “duration,” and so the formula in “end” will be executed to calculate the value “4/24/2015” for cell [End:2]. In row 3, values have been entered for “end” and “duration,” and so the formula in “start” will be executed to calculate the value “8/29/2015” for cell [Start:3]. In row 4, values have been entered for “start,” “end,” and “duration.” In some embodiments, this may have occurred by virtue of a paste operation, or by virtue of manual entry of each of the values. For this row, any of the functions may be executed in order to check the entered values. In row 5, values have again been entered for “start,” end,” and “duration.” Because the value entered in “duration” does not match the value calculated based on the formula, an indication of an error (illustrated as an exclamation point) is presented.

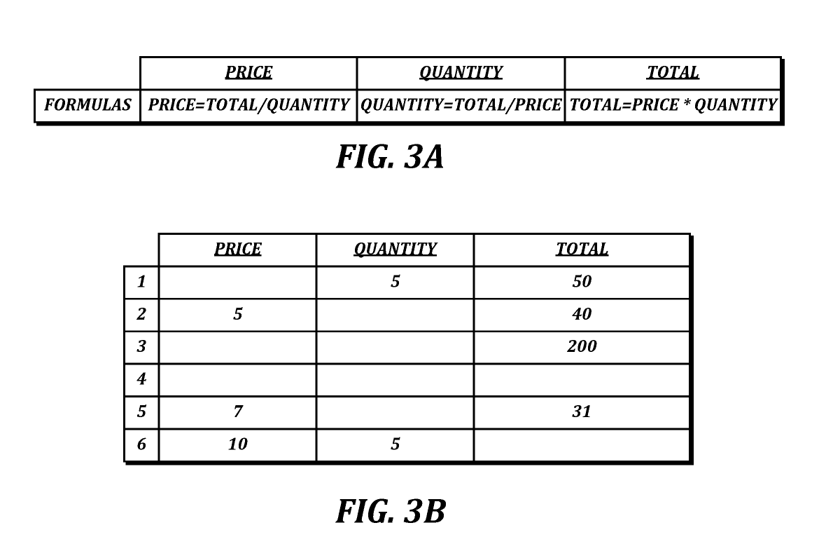

FIGS. 3A and 3B are illustrations of tabular data as managed by exemplary embodiments of systems according to various aspects of the present disclosure. FIG. 3A illustrates formulas that are associated with a table that includes a “price” column, a “quantity” column, and a “total” column. The formula associated with the “total” column multiplies the values in the “price” column and the “quantity” column. The complementary formulas in the “price” and “quantity” columns may be entered manually or may be automatically generated by the system based on the manual entry of the formula in the “total” column. In some embodiments, the values in the “quantity” column may be limited to whole numbers to, for example, support products that are not divisible into smaller quantities.

FIG. 3B illustrates insertion of values into the table using a simple “left-to-right” precedence rule. Under such a rule, a value or formula result in a column further to the left has precedence over a value or formula result in a column further to the right. In row 1, values have been entered for “quantity” and “total.” Because all of its referenced cells have values, the formula in the “price” column will be executed to compute the value “10.” In some embodiments, the value “10” would be inserted into cell [Price:1]. In some embodiments, if a value other than “10” was manually entered into cell [Price:1] (either to overwrite the computed value or inserted before the computed value was inserted into the cell), the left-to-right precedence rule causes the value “10” to be accepted in the cell (because the left-most column has the highest precedence), causes the value “5” to be retained in cell [Quantity:1] (because the second column has a higher precedence than the third column), and causes the value “50” in cell [Total:1] to either be recalculated or to be flagged as an error.

In row 2, values have been entered for “price” and “total,” and the formula in the “quantity” column will be executed to compute the value “8.” In some embodiments, if a value other than “8” is entered into cell [Quantity:2], the left-to-right precedence rule will cause the value “8” to be entered into cell [Quantity:2] (because the second column has precedence over the third column), the value for “5” in cell [Price:2] to be retained (because the left-most column has highest priority), and the value “40” in cell [Total:2] to either be recalculated or to be flagged as an error.

Row 3 only includes a value for “total,” and row 4 is empty. Neither of these rows would cause formulas to execute or the precedence rules to be exercised, because not enough information is available to execute any of the formulas.

As discussed above, the column “quantity” may be assigned to a whole number data type. Accordingly, in row 5, a value of “7” has been entered for “price” and a value of “31” has been entered for “total.” This would cause the formula in “quantity” to be automatically executed, because all of its referenced cells would include values. Execution of the formula would result in the value “4.43,” which would not be a valid whole number value. Because the precedence rules rank the center column higher than the right-most column, an error may be flagged on the “quantity” column, or the “quantity” value may be cleared or not entered due to the fact that it will lead to an invalid value in a column with higher precedence.

Similarly, in row 6, the value “10” has been entered in “price” and the value “5” has been entered in “quantity.” The formula in “total” would automatically execute, and would compute the value “50.” If a value other than “50” is manually entered into the “total” column for row 6, the precedence rules will cause the entry to be flagged as an error, will block entry of the value, and/or take any other suitable action based on the fact that the “total” column is of lowest priority and the specified value does not match the computed value.

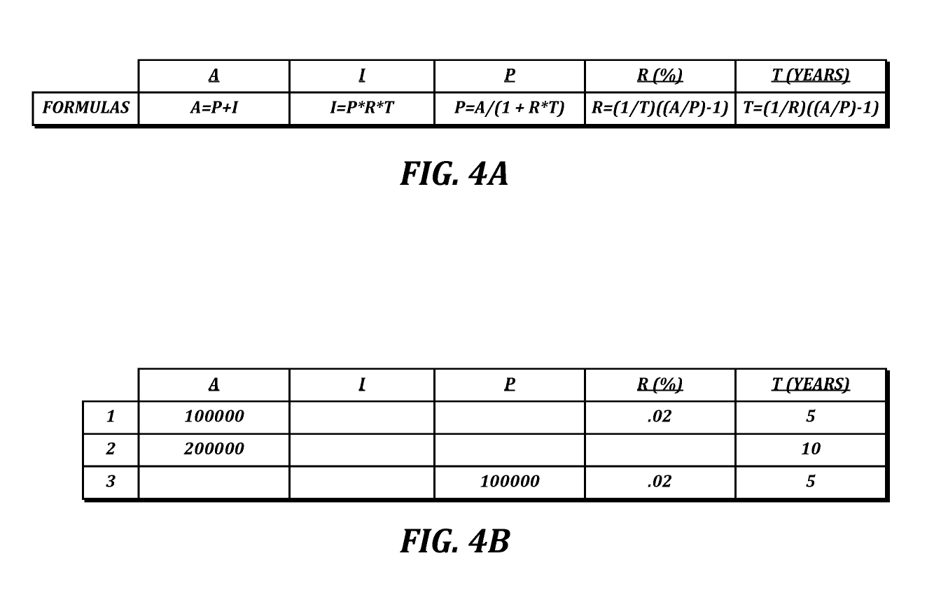

FIGS. 4A and 4B are further illustrations of tabular data as managed by exemplary embodiments of systems according to various aspects of the present disclosure. FIG. 4A illustrates columns and formulas for implementing a simple interest calculator. The illustrated columns include an “A” column for a total accrued amount, an “I” column for an interest amount, a “P” column for a principal amount, a “R” column for a rate of interest (in decimal percent per time period), and a “T” column for a number of time periods. The accrued amount of an investment (A) is the original principal (P) plus the accumulated simple interest I, where I is the principal (P) times the rate of interest (R) times the number of time periods (T). In some embodiments, a user may enter the definitions of the formulas in the “A” column and the “I” column. Thereafter, the system may automatically use these formulas together to derive the formulas for the “P,” “R,” and “T” columns as discussed above. FIG. 4A illustrates each of the formulas after having been derived and associated with the columns.

FIG. 4B illustrates insertion of values into the table using an “order of entry” precedence rule. As shown in row 1, columns “A,” “R,” and “T” include entered values. At this point, the formula in column “I” would not have all of its prerequisite values yet, so it would not be calculated. However, the formula in column “P” would have all of its prerequisite values, and so the formula would be executed to calculate the value “90909.09” for “P.” Thereafter, the system may detect that all of the prerequisites for column “I” are now present, and the formula in column “I” would be executed to calculate the value “9090.91.” In some embodiments, the value for “P” may be entered into the cell [P:1] in order to cause execution of the formula in column “I”. In some embodiments, both of the values for “P” and “I” may be calculated but not committed to the cells, and may be used instead to check for errors in manual entries made to these cells.

In row 2, the entry of values in the “A” column and the “T” column would not cause any formulas to be executed, because none of the formulas have all of their prerequisite values present. In row 3, the entry of the values into the “P,” “R,” and “T” columns may cause execution of the formula in column “I” because all of its prerequisites are present, and then may cause execution of the formula in column “A” because all of its prerequisites are present once the value for column “I” is calculated. Again, the values for “A” and “I” may be inserted into the cells, may be used as autocomplete suggestions, may be used for checking consistency of manually entered data, or for any other purpose.

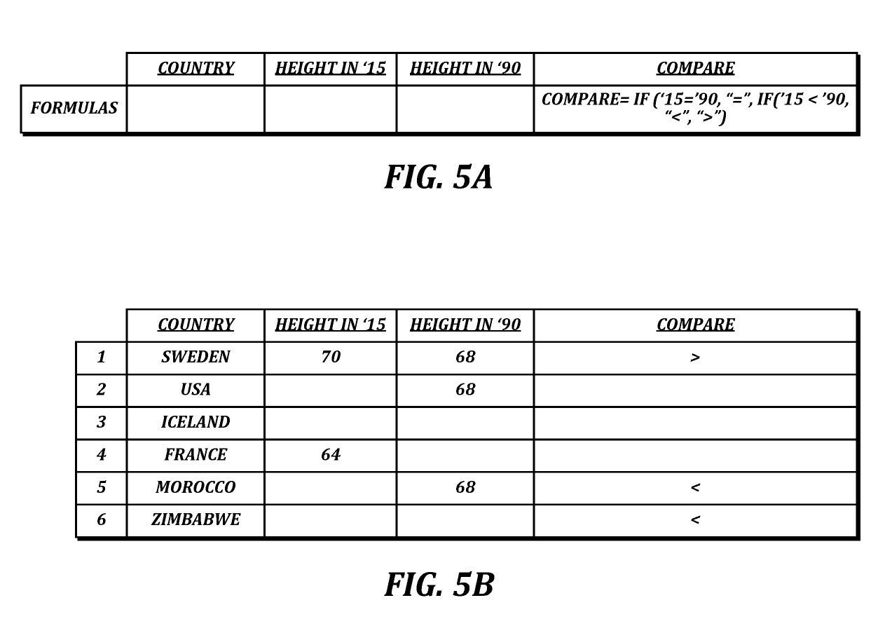

FIGS. 5A and 5B are further illustrations of tabular data as managed by exemplary embodiments of systems according to various aspects of the present disclosure. FIG. 5A illustrates that logical functions may also be managed by exemplary embodiments of the present disclosure. In the “compare” column, a function including a set of logical comparisons has been entered. The result of the function is a “=” character if the value of the “Height in '15” column is equal to the value of the “Height in '90” column, a “<” character if the value of the “Height in '15” column is less than the value of the “Height in '90” column, and otherwise is a “>” character. In some embodiments, the system may rearrange these functions in order to provide complementary functions in the “Height in '15” and “Height in '90” columns. For example, a function in the “Height in '15” column may be generated to perform a check to ensure that a value inserted therein has the relationship specified in the “compare” column with respect to the “Height in '90” column, and would otherwise cause an error message to be displayed or block entry of the value. In some embodiments, the “compare” column may be locked out from user input, and would merely present comparisons based on user entered data in the other columns. In some embodiments, the “compare” column may be locked but pre-populated, and a precedence rule for locked columns would cause errors to be displayed if a user attempted to enter values that did not meet the comparison requirement. In some embodiments, a left-to-right or order-of-entry rules would cause other columns to show errors, based on those particular rules.

FIG. 5B illustrates insertion of values into the table illustrated in FIG. 5A. In row 1, all of the values have been entered and are internally consistent, so execution of the formula in the “compare” column does not cause an error message to be generated. In rows 2, 3, and 4, the formulas in the “compare” column have not yet been executed because not all of the prerequisite values are present. In row 5, the complementary formula in column “height in '15” may be executed upon entry of a value for the “height in '15” column, and may block entry of the value or display an error message if the value does not meet the condition established in the “compare” column. Similarly, in row 6, the value entered in the “compare” column may be stored without executing any of the formulas, because none of the formulas have all of their precedent values completed. Upon entry of values into both of the “height in '15” and “height in ‘90” columns, the functions may be executed and error messages may be presented (or the entries may be blocked) if the formulas do not agree.

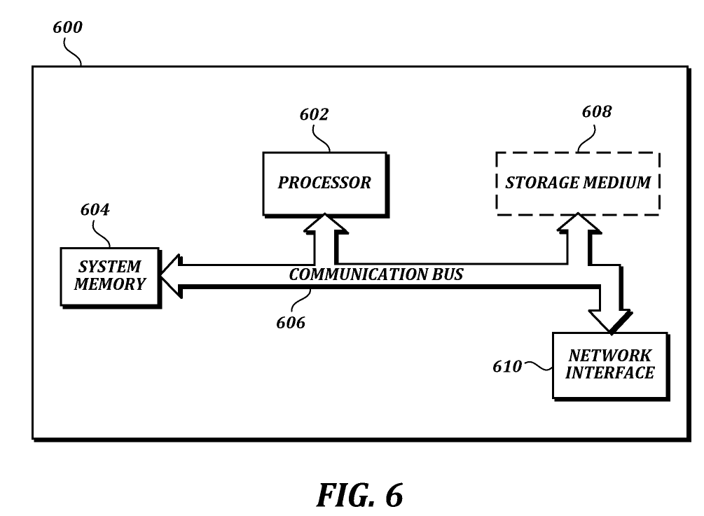

One of ordinary skill in the art will recognize that the figures and other disclosure provided above describe spreadsheet functionality provided by a computing device. Such functionality is provided by a computing device and is used to organize, format, display, and automatically manage information in a tabular format that is stored on a computer-readable medium. FIG. 6 is a block diagram that illustrates aspects of an exemplary computing device 600 appropriate for use with embodiments of the present disclosure. While FIG. 6 is described with reference to a computing device that is implemented as a device on a network, the description below is applicable to servers, personal computers, mobile phones, smart phones, tablet computers, embedded computing devices, and other devices that may be used to implement portions of embodiments of the present disclosure. Moreover, those of ordinary skill in the art and others will recognize that the computing device 600 may be any one of any number of currently available or yet to be developed devices.

In its most basic configuration, the computing device 600 includes at least one processor 602 and a system memory 604 connected by a communication bus 606. Depending on the exact configuration and type of device, the system memory 604 may be volatile or nonvolatile memory, such as read only memory (“ROM”), random access memory (“RAM”), EEPROM, flash memory, or similar memory technology. Those of ordinary skill in the art and others will recognize that system memory 604 typically stores data and/or program modules that are immediately accessible to and/or currently being operated on by the processor 602. In this regard, the processor 602 may serve as a computational center of the computing device 600 by supporting the execution of instructions.

As further illustrated in FIG. 6, the computing device 600 may include a network interface 610 comprising one or more components for communicating with other devices over a network. Embodiments of the present disclosure may access basic services that utilize the network interface 610 to perform communications using common network protocols. The network interface 610 may also include a wireless network interface configured to communicate via one or more wireless communication protocols, such as WiFi, 2G, 3G, LTE, WiMAX, Bluetooth, and/or the like.

In the exemplary embodiment depicted in FIG. 6, the computing device 600 also includes a storage medium 608. However, services may be accessed using a computing device that does not include means for persisting data to a local storage medium. Therefore, the storage medium 608 depicted in FIG. 6 is represented with a dashed line to indicate that the storage medium 608 is optional. In any event, the storage medium 608 may be volatile or nonvolatile, removable or nonremovable, implemented using any technology capable of storing information such as, but not limited to, a hard drive, solid state drive, CD ROM, DVD, or other disk storage, magnetic cassettes, magnetic tape, magnetic disk storage, and/or the like.

As used herein, the term “computer-readable medium” includes volatile and non-volatile and removable and non-removable media implemented in any method or technology capable of storing information, such as computer readable instructions, data structures, program modules, or other data. In this regard, the system memory 604 and storage medium 608 depicted in FIG. 6 are merely examples of computer-readable media. Computer-readable media can be used to store data for use by programs. Accordingly, the terms “electronic spreadsheet,” “grid,” “table,” “cell,” “spreadsheet data,” “sheet data,” “column entry,” “row entry,” and others used herein describe display formats and logical inter-relationships for information stored on a computer-readable medium of a computing device 600.

Suitable implementations of computing devices that include a processor 602, system memory 604, communication bus 606, storage medium 608, and network interface 610 are known and commercially available. For ease of illustration and because it is not important for an understanding of the claimed subject matter, FIG. 6 does not show some of the typical components of many computing devices. In this regard, the computing device 600 may include input devices, such as a keyboard, keypad, mouse, microphone, touch input device, touch screen, tablet, and/or the like. Such input devices may be coupled to the computing device 600 by wired or wireless connections including RF, infrared, serial, parallel, Bluetooth, USB, or other suitable connections protocols using wireless or physical connections. Similarly, the computing device 600 may also include output devices such as a display, speakers, printer, etc. Since these devices are well known in the art, they are not illustrated or described further herein.

As will be appreciated by one skilled in the art, the specific routines described above in the flowcharts may represent one or more of any number of processing strategies such as event-driven, interrupt-driven, multi-tasking, multi-threading, and the like. As such, various acts or functions illustrated may be performed in the sequence illustrated, in parallel, or in some cases omitted. Likewise, the order of processing is not necessarily required to achieve the features and advantages, but is provided for ease of illustration and description. Although not explicitly illustrated, one or more of the illustrated acts or functions may be repeatedly performed depending on the particular strategy being used. Computer interfaces may be included that allow users and/or other software processes to input conditions and/or rules, and/or to inspect, modify, test, customize, re-order, or prioritize one or more rules or processes used by embodiments of the present disclosure. Further, these FIGURES may graphically represent code to be programmed into a computer-readable storage medium associated with a computing device.

While illustrative embodiments have been illustrated and described, it will be appreciated that various changes can be made therein without departing from the spirit and scope of the invention.

The embodiments of the invention in which an exclusive property or privilege is claimed are defined as follows:

1. A computing device configured to provide a self-programming tabular data interface, wherein the computing device is configured to:
receive an entry of a formula into a first tabular data cell, wherein the formula performs a calculation that refers to at least a second tabular data cell;
automatically determine an inverse of the formula; and
automatically insert the inverse of the formula into the second tabular data cell.

2. A computing device for inferring tabular data processing rules without human intervention, wherein the computing device is configured to:
receive an entry of a formula into a first tabular data cell, wherein the formula performs a calculation that refers to at least a second tabular data cell and a third tabular data cell;
automatically rearrange the formula to solve for the second tabular data cell to create a first rearranged formula;
associate the first rearranged formula with the second tabular data cell;
automatically rearrange the formula to solve for the third tabular data cell to create a second rearranged formula; and
associate the second rearranged formula with the third tabular data cell.

3. The computing device of claim 2, further configured to:
receive an entry of a value into the first tabular data cell;
receive an entry of a value into the second tabular data cell; and
automatically populate a value in the third tabular data cell using the second rearranged formula.

4. The computing device of claim 2, further configured to:
receive an entry of a first value into the first tabular data cell;
receive an entry of a second value into the second tabular data cell; and
in response to detecting a submission of a third value for entry into the third tabular data cell:
check consistency of the third value using the second rearranged formula;
in response to determining that the third value is a solution to the second rearranged formula, allowing entry of the third value into the third tabular data cell; and
in response to determining that the third value is not a solution to the second rearranged formula, presenting an alert.

5. A computing device for providing a tabular data management interface, wherein the computing device is configured to:
store a formula execution hierarchy that indicates one or more prerequisites for automatically evaluating one or more formulas in the tabular data management interface;
receive an input into a first column of the tabular data management interface;
determine, using the formula execution hierarchy, a formula in a second column of the tabular data management interface that can be executed using the input into the first column; and
automatically execute the formula in the second column using the input into the first column.

6. The computing device of claim 5, further configured to:
determine, using the formula execution hierarchy, a third column that must contain data before the formula in the second column can be executed; and
provide an indication to prompt a user to input data into the third column.

7. The computing device of claim 5, wherein the formula in the second column references data in the first column, and wherein a formula in the first column references data in the second column.

8. The computing device of claim 5, wherein at least one column in the tabular data management interface is locked to user input.

9. The computing device of claim 5, wherein at least one column in the tabular data management interface is hidden from a user.

10. The computing device of claim 5, further configured to:
provide an interface that allows the formula execution hierarchy to be modified.

11. The computing device of claim 5, further configured to:
store a set of precedence rules that indicate conditions under which user entries are to be accepted that contradict existing data in the tabular data management interface.

12. The computing device of claim 11, wherein at least one precedence rule indicates that earlier entered data has precedence over later entered data.

13. The computing device of claim 11, wherein at least one precedence rule indicates that manually entered data has precedence over automatically generated data.

14. The computing device of claim 11, wherein at least one precedence rule indicates that data in a first column has precedence over data in a second column.

15. The computing device of claim 11, further configured to:
receive data in a first column;
execute a formula in a second column, wherein a result of the formula is used for a new value in the second column, wherein the second column includes a previous value before execution of the formula, and wherein execution of the formula uses the received data in the first column and data in a third column; and
upon determining that the new value does not match the previous value:
overwrite the previous value with the new value in response to determining that the precedence rules indicate that the first column has precedence over the second column; and
indicate an error in the first column instead of overwriting the previous value with the new value in response to determining that the precedence rules indicate that the second column has precedence over the first column.
